(19) United States
(12) Patent Application Publication
(10) Pub. No.: US 2015/0043832 A1
(43) Pub. Date: Feb. 12, 2015

(54) INFORMATION PROCESSING APPARATUS, INFORMATION PROCESSING METHOD, AND COMPUTER READABLE MEDIUM

(71) Applicant: FUJI XEROX CO., LTD., Tokyo (JP)

(72) Inventors: Satoshi KUBOTA, Kanagawa (JP); Shunichi KIMURA, Kanagawa (JP)

(73) Assignee: FUJI XEROX CO., LTD., Tokyo (JP)

(21) Appl. No.: 14/189,263

(22) Filed: Feb. 25, 2014

(30) Foreign Application Priority Data
Aug. 6, 2013 (JP) 2013-163050

(51) Int. Cl. G06K 9/00

(52) U.S. Cl. CPC G06K 9/00442; G06K 9/00993
USPC 382/229

(57) ABSTRACT

An information processing apparatus includes a storage unit, an interpretation unit, and a correction unit. The storage unit stores plural correction instructions. The interpretation unit interprets a correction instruction stored in the storage unit. The correction unit corrects a recognized character string in accordance with the correction instruction interpreted by the interpretation unit. The interpretation unit determines the type of the correction instruction, and extracts a first character string including one or more characters serving as a target of the correction instruction and a second character string obtained by performing conversion of a part of or whole the first character string, in accordance with the type of the correction instruction. The correction unit, in a case where the first character string exists in the recognized character string, converts a part of or whole the first character string within the recognized character string into the second character string.

### CROSS-REFERENCE TO RELATED APPLICATIONS

This application is based on and claims priority under 35 USC 119 from Japanese Patent Application No. 2013-163050 filed Aug. 6, 2013.

### BACKGROUND

### Technical Field

The present invention relates to an information processing apparatus, an information processing method, and a computer readable medium.

### SUMMARY

According to an aspect of the invention, there is provided an information processing apparatus including a storage unit, an interpretation unit, and a correction unit. The storage unit stores plural correction instructions. The interpretation unit interprets a correction instruction stored in the storage unit. The correction unit corrects a recognized character string in accordance with the correction instruction interpreted by the interpretation unit. The interpretation unit determines the type of the correction instruction, and extracts a first character string including one or more characters serving as a target of the correction instruction and a second character string obtained by performing conversion of a part of or whole the first character string, in accordance with the type of the correction instruction. The correction unit, in a case where the first character string exists in the recognized character string, converts a part of or whole the first character string within the recognized character string into the second character string.

### BRIEF DESCRIPTION OF THE DRAWINGS

Exemplary embodiments of the present invention will be described in detail based on the following figures, wherein:

FIG. 1 is a schematic module configuration diagram of a configuration example of a first exemplary embodiment;

FIG. 2 is a flowchart illustrating a processing example in the first exemplary embodiment;

FIGS. 3A and 3B are explanatory diagrams illustrating an example of a correction instruction;

FIGS. 4A and 4B are explanatory diagrams illustrating examples of correction parameters;

FIGS. 5A and 5B are explanatory diagrams illustrating an example of a correction instruction;

FIG. 6 is an explanatory diagram illustrating an example of a correction parameter;

FIG. 7 is a schematic module configuration diagram of a configuration example of a second exemplary embodiment;

FIG. 8 is a flowchart illustrating a processing example in the second exemplary embodiment;

FIG. 9 is an explanatory diagram illustrating an example of correction instruction data;

FIG. 10 is a schematic module configuration diagram of a configuration example of a third exemplary embodiment;

FIG. 11 is a flowchart illustrating a processing example in the third exemplary embodiment;

FIG. 12 is an explanatory diagram illustrating an example of a correction instruction list;

FIGS. 13A, 13B, 13C, and 13D are explanatory diagrams illustrating examples of correction instructions; and

FIG. 14 is a block diagram illustrating an example of a hardware configuration of a computer implementing an exemplary embodiment.

### DETAILED DESCRIPTION

Various exemplary embodiments of the present invention will be hereinafter described with reference to the attached drawings.

### First Exemplary Embodiment

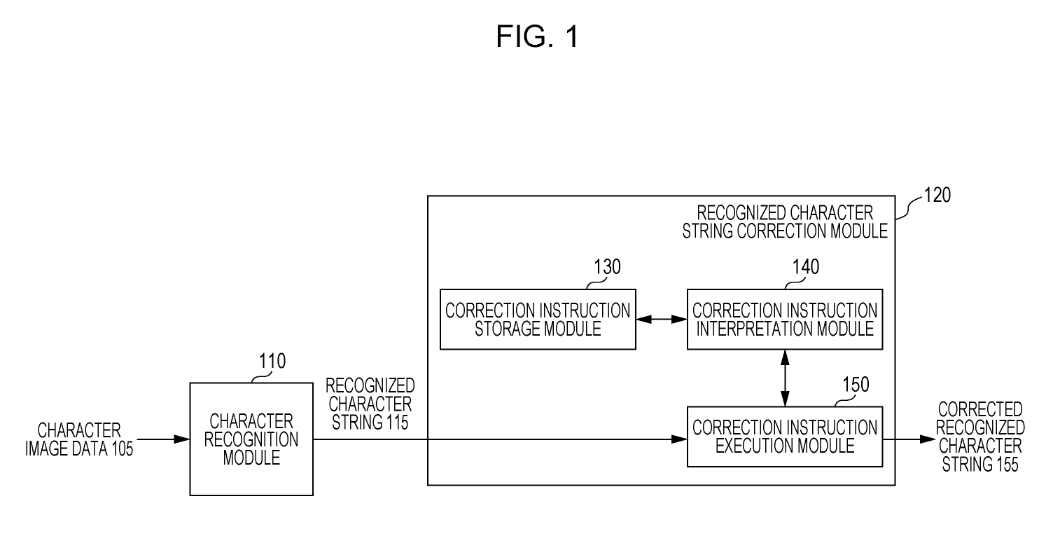

FIG. 1 is a schematic module configuration diagram of a configuration example of a first exemplary embodiment.

Generally, the term “module” refers to a component such as software (a computer program), hardware, or the like, which may be logically separated. Therefore, a module in an exemplary embodiment refers not only to a module in a computer program but also to a module in a hardware configuration. Accordingly, through an exemplary embodiment, a computer program for causing the component to function as a module (a program for causing a computer to perform each step, a program for causing a computer to function as each unit, and a program for causing a computer to perform each function), a system, and a method are described. However, for convenience of description, the terms “store”, “cause something to store”, and other equivalent expressions will be used. When an exemplary embodiment relates to a computer program, the terms and expressions mean “causing a storage device to store”, or “controlling a storage device to store”. A module and a function may be associated on a one-to-one basis. In the actual implementation, however, one module may be implemented by one program, multiple modules may be implemented by one program, or one module may be implemented by multiple programs. Furthermore, multiple modules may be executed by one computer, or one module may be implemented by multiple computers in a distributed computer environment or a parallel computer environment. Moreover, a module may include another module. Note that the term “connection” hereinafter may refer to logical connection (such as data transfer, instruction, and cross-reference relationship between data) as well as physical connection. The term “being predetermined” means being set prior to target processing being performed. “Being predetermined” represents not only being set prior to processing in an exemplary embodiment but also being set even after the processing in the exemplary embodiment has started, in accordance with the condition and state at that time or in accordance with the condition and state during a period up to that time, as long as being set prior to the target processing being performed. When there are plural “predetermined values”, the values may be different from one another, or two or more values (obviously, including all the values) may be the same. The term “in the case of A, B is performed” represents “a determination as to whether it is A or not is performed, and when it is determined to be A, B is performed”, unless the determination of whether it is A or not is not required.

Moreover, a “system” or an “apparatus” may be implemented not only by multiple computers, hardware, apparatuses, or the like connected through a communication unit such as a network (including a one-to-one communication connection), but also by a single computer, hardware, an apparatus, or the like. The term “apparatus” and “system” are used as synonymous terms. Obviously, the term “system” does not include social “mechanisms” (social system), which are only artificially arranged.

Furthermore, for each process in a module or for individual processes in a module performing plural processes, target information is read from a storage device and a processing result is written to the storage device after the process is performed. Therefore, the description of reading from the storage device before the process is performed or the description of writing to the storage device after the process is performed may be omitted. The storage device may be a hard disk, a random access memory (RAM), an external storage medium, a storage device using a communication line, a register within a central processing unit (CPU), or the like.

A recognized character string correction module 120 according to the first exemplary embodiment corrects a recognized character string 115, which is a processed result of a character recognition module 110, and outputs a corrected recognized character string 155. As illustrated in the example of FIG. 1, the recognized character string correction module 120 includes a correction instruction storage module 130, a correction instruction interpretation module 140, and a correction instruction execution module 150.

A character recognition technology is known to identify and recognize characters in a document image and convert them into a character code.

The existing character recognition technology is capable of recognizing a character at a relatively high accuracy of character recognition if the character is a single-unit character (hereinafter, referred to as a “single character”) which is segmented beforehand as a character or those in a printed document.

However, with a document using a complicated layout or a handwritten document, due to a mistake in segmentation of a single character, disparities in the handwritten character quality (disparities in the character size or character pitch), or the like, the accuracy of character recognition is greatly reduced and more characters tend to be erroneously recognized.

Accordingly, a technology for detecting and correcting an erroneously recognized character in a character recognition technology is required.

The character recognition module 110 is connected to the correction instruction execution module 150 of the recognized character string correction module 120. The character recognition module 110 receives character image data 105, recognizes the character image data 105, and outputs the recognized character string 115. The character recognition here may be done using an existing recognition technology. For example, the character recognition module 110 segments from electronic document image data the character image data 105 corresponding to a character string, sequentially segments from character image data 105 segmentable single character candidate regions, recognizes each of the segmented single character candidate regions, and outputs the recognized character string 115 which is the recognition result.

The recognized character string correction module 120 corrects the recognized character string 115 which has been output from the character recognition module 110.

The correction instruction storage module 130 is connected to the correction instruction interpretation module 140. The correction instruction storage module 130 stores multiple correction instructions. Specifically, the correction instruction storage module 130 stores multiple correction methods for a character string. A correction method, for example, may be any of the following or a combination of the following: a character merging instruction, a character separation instruction, a character exchange instruction, and a candidate character addition instruction. A correction instruction includes a correction command which represents a method of correcting a character string and a correction parameter necessary for the correction command. Furthermore, the same correction instruction includes multiple different corresponding correction parameters. A correction parameter for a correction command may be a character code pattern which has multiple character codes, a character code group which defines the range of a predetermined character code, or the like. A correction command and a corresponding correction parameter will be described later.

The correction instruction interpretation module 140 is connected to the correction instruction storage module 130 and the correction instruction execution module 150. The correction instruction interpretation module 140 interprets a correction instruction stored in the correction instruction storage module 130. In the interpretation processing performed here, a type of a correction instruction is identified, and according to the type of the correction instruction, a first character string having one or more characters, which serves as a target of the correction instruction, and a second character string, which is obtained by performing conversion of a part of or whole the first character string, are extracted. The first character string may be a specific character string or a character string represented by a regular expression.

Specifically, the correction instruction interpretation module 140 determines, from multiple types of correction instructions stored in the correction instruction storage module 130, which correction instruction to employ, and acquires a correction command and a required correction parameter (the above-mentioned first character string and second character string). The determination performed here includes employment of correction instructions in a predetermined order, determination as to whether the combination of correction instructions is inappropriate or not, and the like.

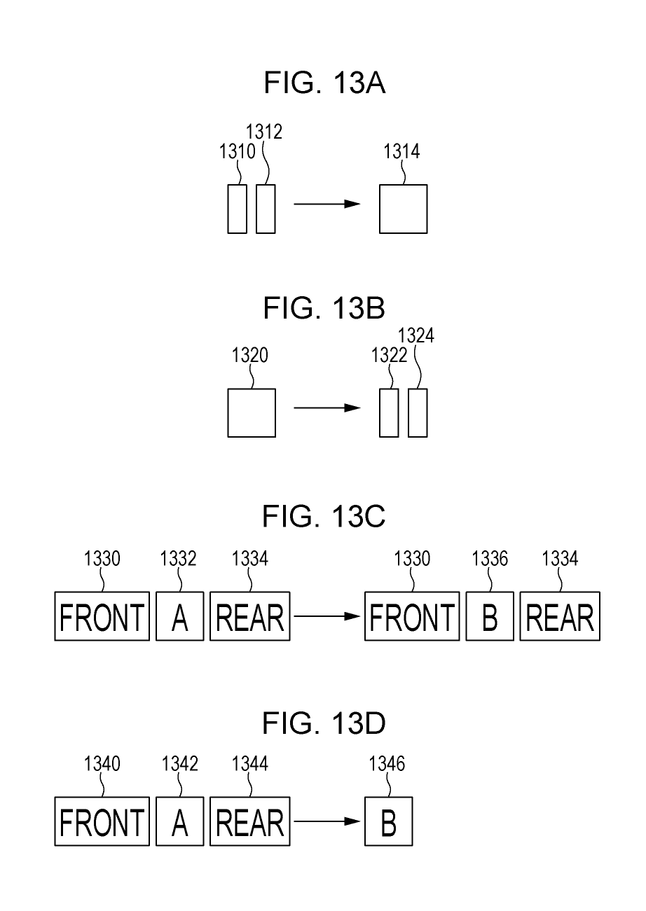

The correction instruction interpretation module 140 performs the following extraction processing as interpretation processing. Examples are given in FIGS. 13A to 13D.

When a correction instruction is an instruction to merge characters, a string of multiple characters is extracted as the first character string and one character is extracted as the second character string. As illustrated by the example in FIG. 13A, a string of consecutive characters of a character 1310 and a character 1312 is merged into a character 1314. When two or more characters are to be dealt with, this instruction is applied plural times.

When a correction instruction is an instruction to separate characters, one character is extracted as the first character string and a string of multiple characters is extracted as the second character string. As illustrated by the example in FIG. 13B, one character which is a character 1320 is separated into two characters of a character 1322 and a character 1324. When a character is to be separated into three or more characters, this instruction is applied plural times.

When a correction instruction is a character exchange instruction, a character string including a target character and characters at its front side and its rear side is extracted as the first character string, and a character string including a replaced character and characters at its front side and its rear side is extracted as the second character string. The character string at the front side and the rear side within the second character string is the same as the character string at the front side and the rear side within the first character string. As illustrated by the example in FIG. 13C, a character 1330, a character 1332, and a character 1334 (the target character 1332, its front character 1330, and its rear character 1334) are replaced with the character 1330, a character 1336, and the character 1334 (the target character 1332 is replaced with the character 1336).

When a correction instruction is an instruction to add a candidate character, a character string including a target character and characters at its front side and its rear side is extracted as the first character string, and a character to be added as a recognition candidate character of the target character is extracted as the second character string. As illustrated by the example in FIG. 13D, in the case of a character 1340, a character 1342, and a character 1344 (the target character 1342, its front character 1340, and its rear character 1344), a recognition candidate character 1346 of the target character 1342 is added. The addition of a candidate character is aimed at adding a candidate character for an easily erroneously recognized character, when in character recognition processing performed by the character recognition module 110, as the recognized character string 115, a predetermined number of recognition candidates (for example, only one character) are output as recognition candidates for each character image. For example, a character candidate as a result of character recognition may be added, in the case of making correction through further language processing (for example, matching processing using other language dictionaries, such as morphological analysis) of the corrected recognized character string 155, instead of using the corrected recognized character string 155 as the final correction result.

Interpretation processing by the correction instruction interpretation module 140 is any of the following or a combination of the following: a character merging instruction, a character separation instruction, a character exchange instruction, and a character candidate addition instruction (for example, a combination of a character merging instruction and a character separation instruction, a combination of a character exchange instruction and a character candidate addition instruction, or the like).

In the case where correction instructions include a character merging instruction and a character separation instruction, the correction instruction interpretation module 140 may determine whether or not a second character string of the character merging instruction and a first character string of the character separation instruction are equal to each other. The “determining whether or not a second character string of the character merging instruction and a first character string of the character separation instruction are equal to each other” is done because, when a merging instruction and a separation instruction are made to the same character, it is highly likely that an intended correction is not made. For example, it is possible that an originally recognized character is returned.

If the second character string and the first character string are equal to each other, either of the corresponding merging instruction or separation instruction may be removed. Alternatively, it may be arranged that, for the single recognized character string 115, the corrected recognized character string 155 which has been corrected by the merging instruction and the corrected recognized character string 155 which has been corrected by the separation instruction are generated. As a result, the two character strings (the character string that has been subjected to the merging instruction and the character string that has been subjected to the separation instruction) are output as the results of the correction. As a matter of course, when there are multiple pairs of a merging instruction and a separation instruction, correction instruction strings whose number is equal to the number of the combinations of the correction instruction and the separation instruction are generated. As a result, the corrected recognized character strings 155 whose number is equal to the number of that combinations are output.

The correction instruction execution module 150 is connected to the character recognition module 110 and the correction instruction interpretation module 140. The correction instruction execution module 150, according to the correction instruction interpreted by the correction instruction interpretation module 140, corrects the recognized character string 115. The correction processing here, in the case where a first character string exists within the recognized character string 115, converts a part of or whole the first character string within the recognized character string 115 into the second character string. To know “the case where a first character string exists within the recognized character string 115”, for example, pattern matching processing may be used to search the recognized character string for the first character string.

In other words, the correction instruction execution module 150, based on the acquired correction command and a corresponding correction parameter, determines whether there is a character string necessary to correct within the recognized character string 115, and if such a character string exists, makes a correction according to the correction command and the corresponding correction parameter.

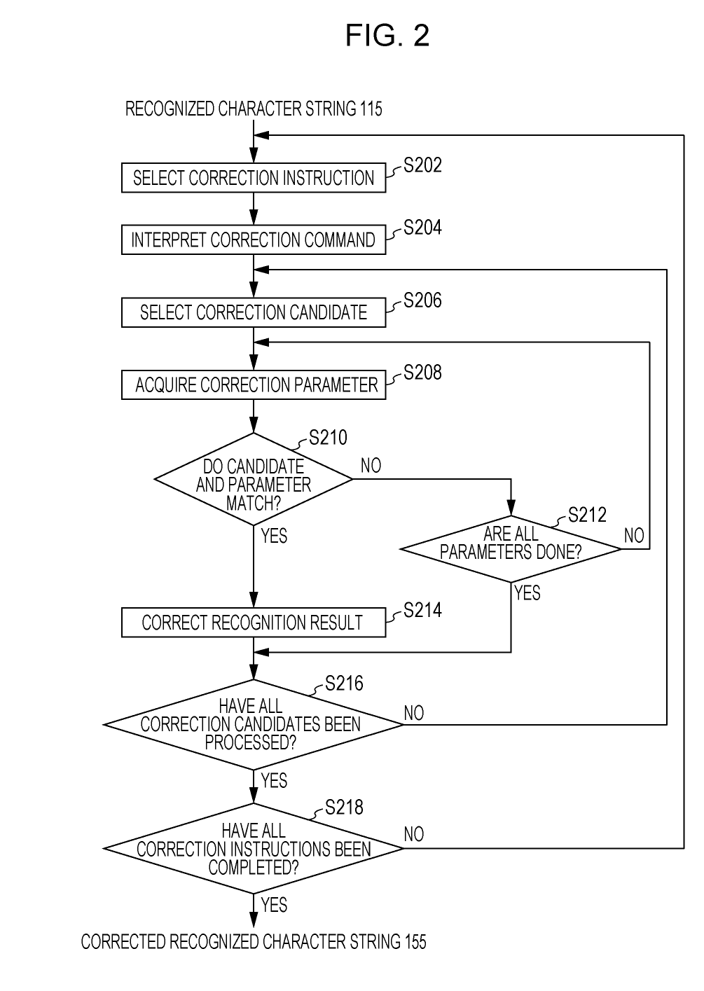

FIG. 2 is a flowchart illustrating a processing example (an example of a recognized character string correction process) by the recognized character string correction module 120 in the first exemplary embodiment. The flow of the process described below is an explanation of a processing flow concerning one character string, and when multiple character strings are processed, processing is repeated from step S202 through step S218 for a required number of character strings.

In step S202, the correction instruction interpretation module 140 selects one correction instruction from multiple correction instructions stored in the correction instruction storage module 130.

In step S204, the correction instruction interpretation module 140 interprets a correction command of the correction instruction selected in step S202. The correction command, as described above, represents a correction method (the above-mentioned character merging instruction, character separation instruction, character exchange instruction, or character candidate addition instruction) of a character string. “Interpretation” mentioned here means to determine which of the above correction method the correction command represents. A correction parameter according to the correction instruction is also extracted.

In step S206, the correction instruction execution module 150 selects a correction character string candidate from the recognized character string 115 received from the character recognition module 110.

In step S208, the correction instruction execution module 150 acquires a correction parameter of the correction instruction. The correction instruction execution module 150 acquires from the correction instruction storage module 130 a correction parameter necessary for the correction command interpreted at the correction instruction interpretation module 140.

In step S210, the correction instruction execution module 150 determines whether the correction character string candidate matches the correction parameter acquired by the correction instruction execution module 150. If the correction character string candidate matches the acquired correction parameter, the process proceeds to step S214, and the correction instruction execution module 150 corrects the correction character string candidate in accordance with the correction method represented by the correction command which has been interpreted at the correction instruction interpretation module 140. If the correction character string candidate does not match the acquired correction parameter, the process goes to step S212.

In step S212, the correction instruction execution module 150 acquires all the different correction parameters of the correction command interpreted at the correction instruction interpretation module 140 and determines whether a matching determination with the correction character string candidate has been made. If matching determination has been made for all the acquired correction parameters, the process proceeds to step S216. If matching determination has not been made for all the acquired correction parameters, the process returns to step S208 and repeats the processing of step S208 and the processing of step S210 for the next correction parameter.

In step S216, the correction instruction execution module 150 determines whether all the correction character string candidates for the received recognized character string 115 have been processed. If there is an unprocessed correction character string candidate, the process returns to step S206, and the processing from step S206 through step S214 is repeated for a new correction character string candidate. If all the correction character string candidates have been processed, the process proceeds to step S218.

In step S218, the correction instruction execution module 150 determines whether processing for all the correction instructions stored in the correction instruction storage module 130 has been completed. If all the correction instructions have been completed, the correction instruction execution module 150 outputs the corrected recognized character string 155 for the recognized character string 115 received from the character recognition module 110. If there is an unprocessed correction instruction, the process goes to step S202 and repeats the processing from step S202 through step S216 for the next correction instruction.

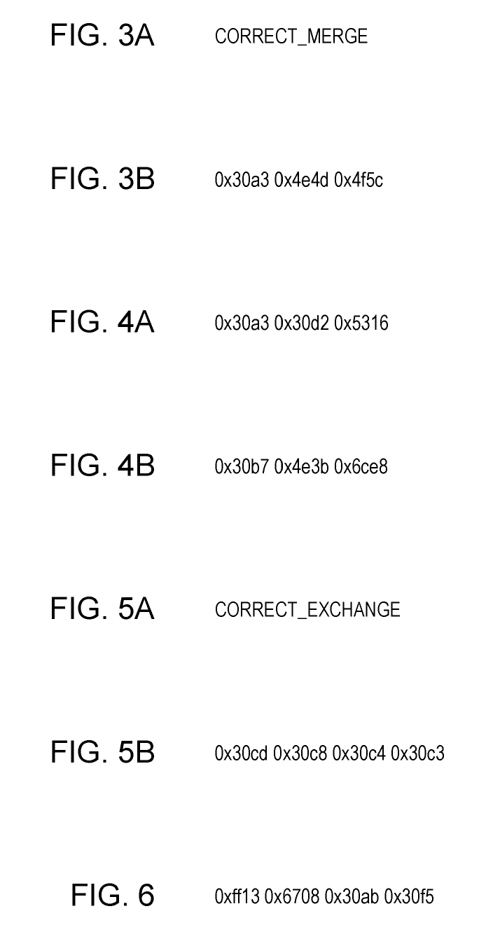

FIGS. 3A and 3B illustrate a specific example of a correction instruction (a correction command and a correction parameter) stored in the correction instruction storage module 130.

FIGS. 3A and 3B illustrate a specific example of a “merging instruction”, which is one of the correction instructions. “CORRECT_MERGE” illustrated in FIG. 3A represents a correction command, and a character code string “0x30a3 0x4e4d 0x4f5c” illustrated in FIG. 3B represents a correction parameter necessary for the correction command “CORRECT_MERGE”. In this example, “0x30a3 0x4e4d” is the first character string and “0x4f5c” is the second character string. The “merging instruction” illustrated in FIGS. 3A and 3B represents that a correction that “if the character code 0x30a3 (left part) and the character code 0x4e4d (right part) are placed side by side, these codes are merged into a character code 0x4f5c (right and left parts merged together)” is performed. As already described, the correction instruction storage module 130 is configured to store, as a correction parameter corresponding to the correction command “CORRECT_MERGE”, not only the character code string illustrated in FIG. 3B, but also multiple parameters, for example, as illustrated in FIGS. 4A and 4B, “0x30a3 0x30d2 0x5316” in FIG. 4A which is, “if a character code 0x30a3 (left part) and a character code 0x30d2 (right part) are placed side by side, these codes are merged into a character code 0x5316 (right and left parts merged together)”, “0x30b7 0x4e3b 0x6ce8” in FIG. 4B which is, “if a character code 0x30b7 (left part) and a character code 0x4e3b (right part) are placed side by side, these codes are merged into a character code 0x6ce8 (right and left parts merged together)”, or the like.

FIGS. 5A and 5B illustrate a specific example of an “exchange instruction”, which is one of the correction instructions. As with the example of the “merging instruction” illustrated in FIGS. 3A and 3B, “CORRECT_EXCHANGE” illustrated in FIG. 5A represents a correction command, and a character code string “0x30cd 0x30c8 0x30c4 0x30c3” illustrated in FIG. 5B represents a correction parameter necessary for the correction command “CORRECT_EXCHANGE”. In this example, “0x30cd 0x30c8 0x30c4” is the first character string and “0x30c3” is the second character string. The “exchange instruction” illustrated in FIGS. 5A and 5B represents that a correction that 0x30c4 (middle part) sandwiched between 0x30cd (left part) and 0x30c8 (right part) is replaced with 0x30c3 (small-sized middle part)” is performed. As in FIGS. 3A and 3B and FIGS. 4A and 4B, for the correction command “CORRECT_EXCHANGE”, multiple correction parameters are stored in the correction instruction storage module 130, and as illustrated in FIG. 6, for example, a correction parameter such as “0xff13 0x6708 0x30ab 0x30f5”, which means that “0x30ab (middle part) sandwiched between 0xff13 (left part) and 0x6708 (right part) is replaced with 0x30f5 (small-sized middle part)” is stored. As a matter of course, multiple correction parameters are stored in the correction instruction storage module 130.

### Second Exemplary Embodiment

In a second exemplary embodiment described below, the recognized character string correction module 120 and a correction instruction are separated to allow addition/deletion of the correction instruction without modifying the recognized character string correction module 120 itself.

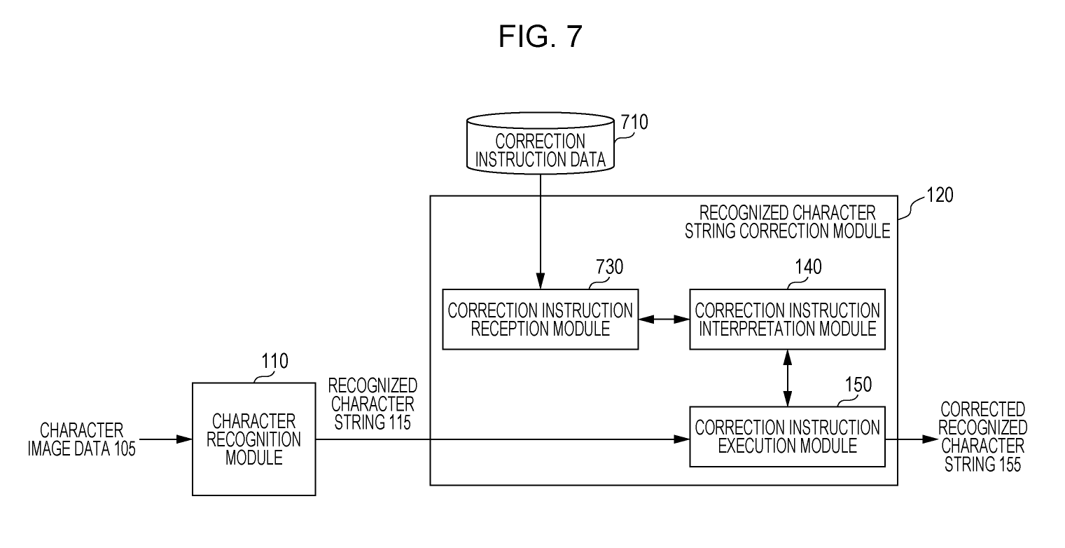

FIG. 7 is a schematic module configuration diagram of a configuration example of the second exemplary embodiment. The sections that are similar to those in the first exemplary embodiment are referred to with the same reference signs, and redundant explanations will be omitted (the same applied hereafter). A correction instruction reception module 730 is connected to the correction instruction interpretation module 140 and correction instruction data 710.

As illustrated by the example in FIG. 7, similar to the character recognition apparatus in the first exemplary embodiment, a character recognition apparatus in the second exemplary embodiment includes the character recognition module 110 and the recognized character string correction module 120. The recognized character string correction module 120 in the second exemplary embodiment includes the correction instruction reception module 730 which receives a correction instruction from the external correction instruction data 710, the correction instruction interpretation module 140 which interprets the received correction instruction, and the correction instruction execution module 150 which executes the interpreted correction instruction to the recognized character string 115 received from the character recognition module 110. The correction instruction interpretation module 140 and the correction instruction execution module 150 are similar to those described in the first exemplary embodiment of the invention.

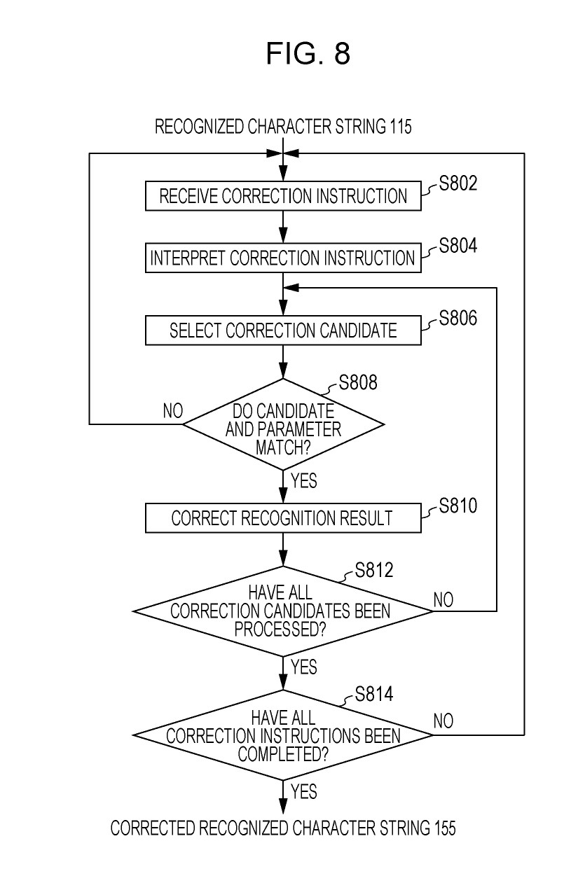

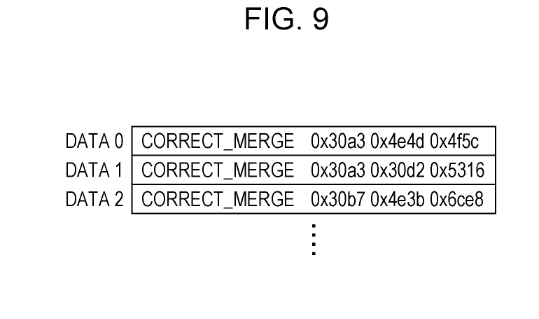

FIG. 8 is a flowchart illustrating a processing example (an example of a recognized character string correction process) by the recognized character string correction module 120 in the second exemplary embodiment. For a correction instruction which is external data stored in the correction instruction data 710 illustrated in FIG. 7, one piece of correction instruction data includes, for example, a correction command and a correction parameter necessary for the correction command, as illustrated in FIG. 9. In other words, each correction instruction includes a correction command and a correction parameter.

In step S802, the correction instruction reception module 730 receives a correction instruction from the correction instruction data 710.

In step S804, the correction instruction interpretation module 140 interprets the received correction instruction. In other words, the correction instruction interpretation module 140 determines which correction method the correction command in the correction instruction data 710 represents, and acquires a corresponding correction parameter.

In step S806, the correction instruction execution module 150 selects a correction character string candidate from the recognized character string 115 received from the character recognition module 110.

In step S808, the correction instruction execution module 150 determines whether the correction character string candidate matches the correction parameter. If the correction character string candidate matches the correction parameter, the process proceeds to step S810, and the correction instruction execution module 150 corrects the correction character string candidate in accordance with the correction method represented by the correction command which has been interpreted at the correction instruction interpretation module 140. If the correction character string candidate does not match the correction parameter, the process returns to step S802, and repeats the processing from step S802 through step S806 for a new correction instruction in the correction instruction data 710.

In step S812, the correction instruction execution module 150 determines whether all the correction character string candidates for the received recognized character string 115 have been processed. If there is an unprocessed correction character string candidate, the process returns to step S806, and the processing from step S806 through step S810 is repeated for a new correction character string candidate. If all the correction character string candidates have been processed, the process proceeds to step S814.

In step S814, the correction instruction execution module 150 determines whether processing for all the correction instruction data 710 has been completed. If processing for all the correction instruction data 710 has been completed, the correction instruction execution module 150 outputs the corrected recognized character string 155 for the recognized character string 115 received from the character recognition module 110. If there is unprocessed correction instruction data 710, the process returns to step S802 and repeats the processing from step S802 through step S812 for the next correction instruction data 710.

In the second exemplary embodiment, the correction instruction data 710 is arranged outside the recognized character string correction module 120 to separate the recognized character string correction module 120 from a correction instruction, thereby enabling the addition/deletion of the correction instruction without modifying the recognized character string correction module 120. With this arrangement, a new correction to erroneous recognition is made easy.

### Third Exemplary Embodiment

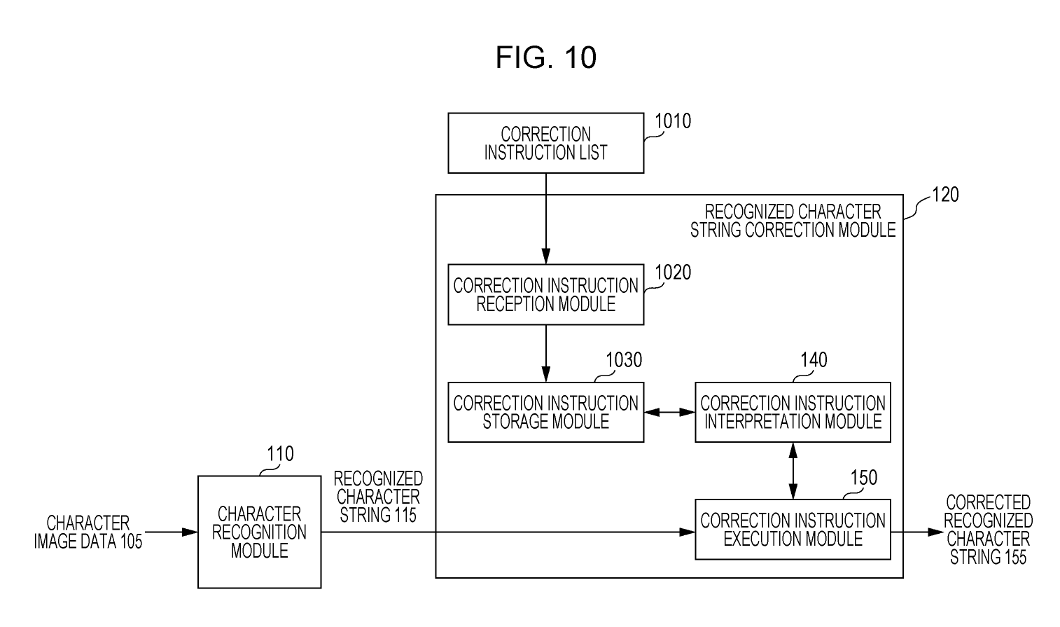

FIG. 10 is a schematic module configuration diagram of a configuration example of a third exemplary embodiment. The recognized character string correction module 120 includes a correction instruction reception module 1020, a correction instruction storage module 1030, the correction instruction interpretation module 140, and the correction instruction execution module 150. The correction instruction reception module 1020 is connected to the correction instruction storage module 1030 and a correction instruction list 1010. The correction instruction storage module 1030 is connected to the correction instruction interpretation module 140 and the correction instruction reception module 1020.

As illustrated in FIG. 10, similar to the first exemplary embodiment, in the third exemplary embodiment, the character recognition module 110 and the recognized character string correction module 120 are connected. The recognized character string correction module 120 in the third exemplary embodiment includes the correction instruction reception module 1020 which receives the correction instruction list 1010 that is an external file, the correction instruction storage module 1030 which, based on a predetermined data structure, stores the correction instruction list 1010 received by the correction instruction reception module 1020, the correction instruction interpretation module 140 which interprets the received correction instruction, and the correction instruction execution module 150 which executes the interpreted correction instruction to the recognized character string 115 received from the character recognition module 110.

The correction instruction reception module 1020 reads the correction instruction list 1010 prepared as an external file of the recognized character string correction module 120 and based on the predetermined data structure, stores in the correction instruction storage module 1030 correction commands representing multiple correction instructions and correction parameter necessary for the correction commands.

The correction instruction storage module 1030, based on the predetermined data format, stores a correction instruction. The data format in the correction instruction storage module 1030 may be, for example, a simple data list structure simply including correction commands and correction parameters as illustrated in FIG. 9. However, in the case where the number of correction instructions is very large, it is preferable to use a data structure achieving efficient search such as a hash data structure.

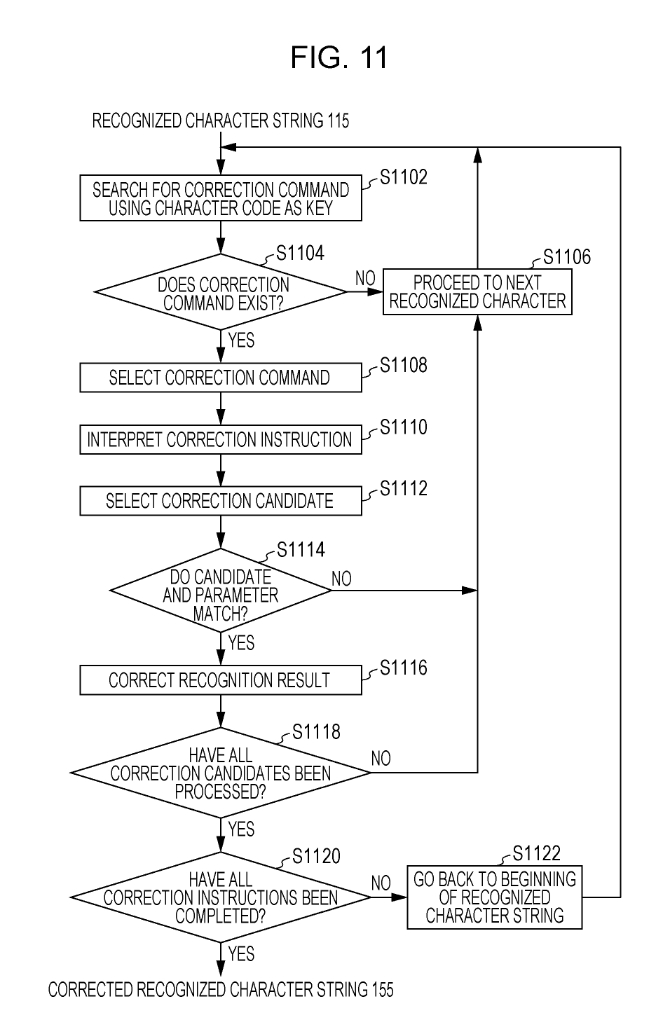

FIG. 11 is a flowchart illustrating a processing example (an example of a recognized character string correction process) by the recognized character string correction module 120 in the third exemplary embodiment. In the processing example here, an example of a recognized character string correction process by the recognized character string correction module 120 in the third exemplary embodiment is explained, where the data structure of the correction instruction storage module 1030 is a hash structure in which a character code, which is a correction parameter, is used as a key and a correction command is a value.

In step S1102, the correction instruction interpretation module 140 uses as a key the character code of a target character of the recognized character string 115 received from the character recognition module 110 and searches for a correction command stored in the correction instruction storage module 1030.

In step S1104, the correction instruction interpretation module 140 proceeds to step S1108 in the case where there is a correction command which matches the key, and in the case where there is no correction command which matches the key, the correction instruction interpretation module 140 proceeds to the next target of the recognized character (step S1106) and repeats the processing of step S1102.

In step S1108, the correction instruction interpretation module 140 selects a predetermined correction command among the found correction commands. The selection of a correction command should follow such rules as the order of execution of correction instructions has been determined in advance.

In step S1110, the correction instruction interpretation module 140 interprets the selected correction command. In other words, the correction instruction interpretation module 140 determines which correction method the correction command represents, and acquires a corresponding correction parameter linked to the correction command stored in the correction instruction storage module 1030.

In step S1112, the correction instruction execution module 150 selects from the recognized character string 115 received from the character recognition module 110 a correction character string candidate necessary for the correction command interpreted in step S1110.

In step S1114, the correction instruction execution module 150 determines whether the correction character string candidate matches the correction parameter. If the correction character string candidate matches the correction parameter, the process proceeds to step S1116, and the correction instruction execution module 150 corrects the correction character string candidate in accordance with the correction method represented by the correction command which has been interpreted at the correction instruction interpretation module 140. If the correction character string candidate does not match the correction parameter, the process proceeds to the next target of the recognized character (step S1106). The process returns to step S1102 and repeats the processing from step S1102 through step S1112.

In step S1118, the correction instruction execution module 150 determines whether all the correction character string candidates for the received recognized character string 115 have been processed. If there is an unprocessed correction character string candidate, the process proceeds to the next target of the recognized character (step S1106). The process returns to step S1102 and repeats the processing from step S1102 through step S1116. If all the correction character string candidates have been processed, the process proceeds to step S1120.

In step S1120, the correction instruction execution module 150 determines whether processing for all the correction instructions necessary for the recognized character string 115 have been completed. If all the correction instructions have been completed, the correction instruction execution module 150 outputs the corrected recognized character string 155 for the recognized character string 115 received from the character recognition module 110. If there is an unprocessed correction instruction, the process goes back to the beginning of the recognized character string 115 (step S1122) and repeats the processing from step S1102 through step S1118.

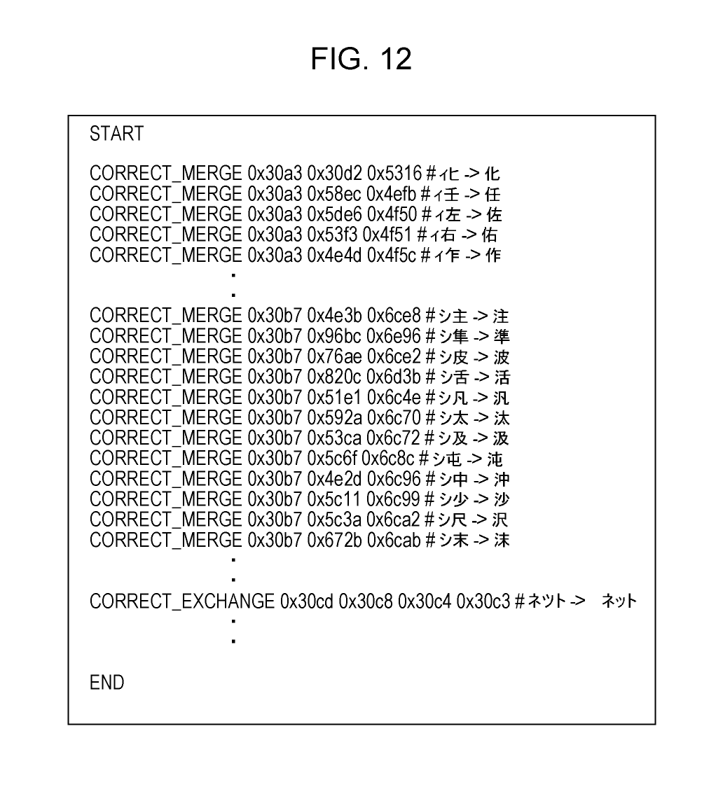

FIG. 12 illustrates a specific example of the correction instruction list 1010 in the third exemplary embodiment, which is prepared as an external file.

In the specific example of the correction instruction list 1010 illustrated in FIG. 12, “START” and “END” are described at the first row and the last row of the list, respectively. “START” at the first row represents that the description that follows is a correction instruction list body and that the description before “START” is not referred to. Likewise, “END” at the last row represents that the description up to “END” is a correction instruction list body and that the description after “END” is not referred to. Before “START” or after “END” may carry information beneficial to users, for example, version information of the correction instruction list or a description method of the correction instruction list body.

The part sandwiched between “START” and “END” is a correction instruction list body, with each row having a “correction command” and a “correction parameter” necessary for the corresponding correction command. For example, there are correction instructions as below: two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; two characters of a “left-side component” and a “right-side component” are merged into “one character obtained by combining the two characters together”; and three characters of a “left-side character”, a “middle character”, and a “right-side character” are replaced with “one character obtained by combining the three characters together with the small-sized middle character”.

The correction instruction reception module 1020 in the third exemplary embodiment reads each row sandwiched between “START” and “END”, converts the read row into a predetermined data structure (for example, a hash structure), and stores the converted data having the predetermined data structure into the correction instruction storage module 1030.

In the third exemplary embodiment, the correction instruction list 1010 is arranged outside the recognized character string correction module 120 to separate the recognized character string correction module 120 from a correction instruction, thereby enabling the addition/deletion of the correction instruction without modifying the recognized character string correction module 120. With this arrangement, a new correction to erroneous recognition is made easy. Furthermore, even in the case where the number of correction instructions increases, it is possible to suppress an increase in the processing time for correcting erroneous recognition by retaining correction instructions in the predetermined data structure in the correction instruction storage module 1030.

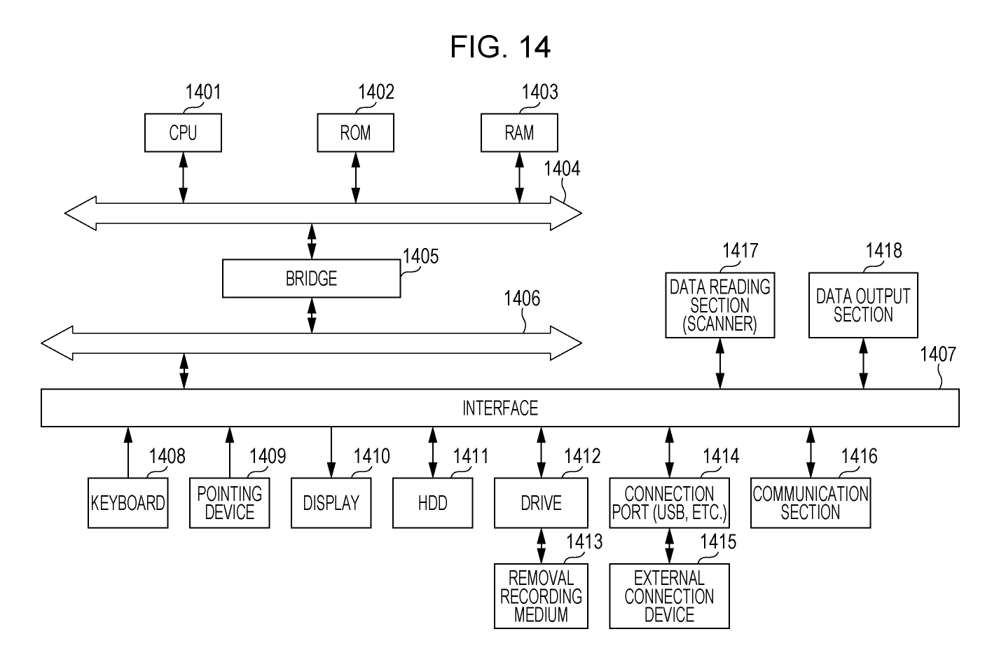

While referring to FIG. 14, a hardware configuration example of an information processing apparatus of an exemplary embodiment will be explained below. The configuration illustrated in FIG. 14 includes, for example, a personal computer (PC) or the like which includes a data reading section 1417, such as a scanner, and a data output section 1418, such as a printer.

A central processing unit (CPU) 1401 is a controller which executes processes according to a computer program describing execution sequences of various modules described in the above exemplary embodiments, that is, the character recognition module 110, the recognized character string correction module 120, the correction instruction storage module 130, the correction instruction interpretation module 140, the correction instruction execution module 150, the correction instruction reception module 730, the correction instruction reception module 1020, and the correction instruction storage module 1030.

A read only memory (ROM) 1402 stores programs and operation parameters used by the CPU 1401. A random access memory (RAM) 1403 stores programs used in execution of the CPU 1401 and parameters or the like, which vary in an appropriate manner in the execution of the CPU 1401. The CPU 1401, the ROM 1402, and the RAM 1403 are connected to one another by a host bus 1404 which includes a CPU bus or the like.

The host bus 1404 is connected, via a bridge 1405, to an external bus 1406, such as a peripheral component interconnect/interface (PCI) bus.

A keyboard 1408 and a pointing device 1409, such as a mouse, are input devices operated by an operator. A display 1410 may be a liquid crystal display, a cathode ray tube (CRT), or the like, which displays various types of information in the form of text or image.

A hard disk drive (HDD) 1411 has a built-in hard disk, drives the hard disk, and records or reproduces programs and information executed by the CPU 1401. In the hard disk, the recognized character string 115, the corrected recognized character string 155, correction instructions, and the like are stored. The hard disk also stores various computer programs including other various data processing programs.

A drive 1412 reads data or programs recorded in an inserted removal recording medium 1413, such as a magnetic disk, an optical disk, a magneto-optical disk, or a semiconductor memory, and provides the data or programs to the RAM 1403 which is connected via an interface 1407, the external bus 1406, the bridge 1405, and the host bus 1404. The removal recording medium 1413 may be used as a data storage area like the hard disk.

A connection port 1414 is a port which allows connection to an external connection device 1415 and has a connection part for a USB, IEEE 1394, or the like. The connection port 1414 is connected to the CPU 1401 and the like, via the interface 1407, the external bus 1406, the bridge 1405, the host bus 1404, and the like. A communication section 1416, which is connected to a communication line, executes data communication processes with the outside. The data reading section 1417 is, for example, a scanner, and executes a reading process of a document. The data output section 1418 is, for example, a printer, and executes an output process of document data.

The hardware configuration example of the information processing apparatus illustrated in FIG. 14 is one example of configuration, and an exemplary embodiment does not need to be limited to the configuration illustrated in FIG. 14. Any configuration is possible as long as it is able to execute the modules described in any of the foregoing exemplary embodiments. For example, a part of modules may be configured by dedicated hardware, such as an application specific integrated circuit (ASIC) or a part of modules may be arranged inside an external system and connected by a communication line. Alternatively, the multiple systems illustrated by FIG. 14 may be connected to each other via communication lines for mutual operations in collaboration. Further, the systems may be integrated in a copying machine, a facsimile machine, a scanner, a printer, or a multifunction machine (an image processing apparatus having two or more functions of a scanner, a printer, a copying machine, a facsimile machine, etc.).

In the above-mentioned exemplary embodiments, the character image data 105 is given as a recognition target of the character recognition module 110, however, the recognition target may be vector data of the order of handwriting in online character recognition. In this case, the character recognition module 110 may execute a handwriting character recognition process for vector data of the order of handwriting.

Among a character merging instruction, a character separation instruction, a character exchange instruction, and a character candidate addition instruction, a predetermined type of correction instruction may be made to execute first. For example, it may be made to execute a character candidate addition instruction followed by other correction instructions. In other words, a character string after a character candidate addition instruction is executed (a character string in which a target character has been replaced with an added character) may be processed as another recognized character string 115 by the recognized character string correction module 120.

The programs described above may be stored in a recording medium and provided or the programs may be supplied through communication. In this case, for example, the programs described above may be considered as an invention of “a computer-readable recording medium which records a program”.

“A computer-readable recording medium which records a program” means a computer-readable recording medium which records a program, used for installation, execution, and distribution of a program.

A recording medium is, for example, a digital versatile disc (DVD), including “a DVD-R, a DVD-RW, a DVD-RAM, etc.”, which are the standard set by a DVD forum, and “a DVD+R, a DVD+RW, etc.”, which are the standard set by a DVD+RW, a compact disc (CD), including a read-only memory (CD-ROM), a CD recordable (CD-R), a CD rewritable (CD-RW), etc., a Blu-ray Disc™, a magneto-optical disk (MO), a flexible disk (FD), a magnetic tape, a hard disk, a read-only memory (ROM), an electrically erasable programmable read-only memory (EEPROM™), a flash memory, a random access memory (RAM), a secure digital (SD) memory card, etc.

The program described above or a part of the program may be recorded in the above recording medium, to be stored and distributed. Furthermore, the program may be transmitted through communication, for example, a wired network or a wireless communication network used for a local area network (LAN), a metropolitan area network (MAN), a wide area network (WAN), the Internet, an intranet, an extranet, or the like, or a transmission medium of a combination of the above networks. Alternatively, the program or a part of program may be delivered by carrier waves.

The above program may be a part of another program or may be recorded in a recording medium along with a different program. Also, the program may be divided and recorded into multiple recording media. As long as they are restorable, they may be stored in any format, such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage unit that stores a plurality of correction instructions;
an interpretation unit that interprets a correction instruction stored in the storage unit; and
a correction unit that corrects a recognized character string in accordance with the correction instruction interpreted by the interpretation unit,
wherein the interpretation unit determines the type of the correction instruction, and extracts a first character string including one or more characters serving as a target of the correction instruction and a second character string obtained by performing conversion of a part of or whole the first character string, in accordance with the type of the correction instruction, and
wherein the correction unit, in a case where the first character string exists in the recognized character string, converts a part of or whole the first character string within the recognized character string into the second character string.

2. The information processing apparatus according to claim 1,
wherein the correction instructions include a character merging instruction and a character separation instruction,
wherein the interpretation unit, in a case where the correction instruction is a character merging instruction, extracts a string of a plurality of characters as the first character string and extracts one character as the second character string, and
wherein the interpretation unit, in a case where the correction instruction is a character separation instruction, extracts one character as the first character string and extracts a string of plurality of characters as the second character string.

3. The information processing apparatus according to claim 1,
wherein the correction instructions include a character exchange instruction and a candidate character addition instruction,
wherein the interpretation unit, in a case where the correction instruction is a character exchange instruction, extracts a character string including a target character and characters at a front side and a rear side of the target character as the first character string and extracts a replaced character and characters at a front side and a rear side of the replaced character as the second character string, and
wherein the interpretation unit, in a case where the correction instruction is a candidate character addition instruction, extracts a character string including a target character and characters at a front side and a rear side of the target character as the first character string and a character to be added as a recognition candidate of the target character as the second character string.

4. The information processing apparatus according to claim 2,
wherein the correction instructions include a character exchange instruction and a candidate character addition instruction,
wherein the interpretation unit, in a case where the correction instruction is a character exchange instruction, extracts a character string including a target character and characters at a front side and a rear side of the target character as the first character string and extracts a replaced character and characters at a front side and a rear side of the replaced character as the second character string, and
wherein the interpretation unit, in a case where the correction instruction is a candidate character addition instruction, extracts a character string including a target character and characters at a front side and a rear side of the target character as the first character string and a character to be added as a recognition candidate of the target character as the second character string.

5. The information processing apparatus according to claim 2,
wherein the interpretation unit determines, in a case where the character merging instruction and the character separation instruction exist as the correction instructions, whether the second character string of the character merging instruction and the first character string of the character separation instruction are equal to each other.

6. The information processing apparatus according to claim 4,
wherein the interpretation unit determines, in a case where the character merging instruction and the character separation instruction exist as the correction instructions, whether the second character string of the character merging instruction and the first character string of the character separation instruction are equal to each other.

7. An information processing method comprising:
storing a plurality of correction instructions;
interpreting a stored correction instruction; and
correcting a recognized character string in accordance with the interpreted correction instruction,
wherein the interpreting determines the type of the correction instruction, and extracts a first character string including one or more characters serving as a target of the correction instruction and a second character string obtained by performing conversion of a part of or whole the first character string, in accordance with the type of the correction instruction, and
wherein the correcting, in a case where the first character string exists in the recognized character string, converts a part of or whole the first character string within the recognized character string into the second character string.

8. A non-transitory computer readable medium storing a program causing a computer to execute a process for information processing, the process comprising:
storing a plurality of correction instructions;
interpreting a stored correction instruction; and
correcting a recognized character string in accordance with the interpreted correction instruction,
wherein the interpreting determines the type of the correction instruction, and extracts a first character string including one or more characters serving as a target of the correction instruction and a second character string obtained by performing conversion of a part of or whole the first character string, in accordance with the type of the correction instruction, and
wherein the correcting, in a case where the first character string exists in the recognized character string, converts a part of or whole the first character string within the recognized character string into the second character string.
